(19) United States
(12) Patent Application Publication
(10) Pub. No.: US 2020/0249357 A1
(43) Pub. Date: Aug. 6, 2020

(54) MEASUREMENT OF THREE DIMENSIONAL COORDINATES USING AN UNMANNED AERIAL DRONE

(71) Applicant: FARO Technologies, Inc., Lake Mary, FL (US)

(72) Inventors: Bernd-Dietmar Becker, Ludwigsburg (DE); Oliver Zweigle, Stuttgart (DE); Tobias Böhret, Aidlingen (DE)

(21) Appl. No.: 16/679,700

(22) Filed: Nov. 11, 2019

Related U.S. Application Data
(60) Provisional application No. 62/799,270, filed on Jan. 31, 2019.

(51) Int. Cl. G01S 17/89; G01S 17/42; B64C 39/02; B64D 47/08; B64D 47/02; B64C 25/32

(52) U.S. Cl. CPC G01S 17/89; G01S 17/42; B64C 39/024; B64D 47/08; B64D 47/02; B64C 2201/141; B64C 2201/127; B64C 2201/027; B64C 2201/108; B64C 2201/146; B64C 25/32

(57) ABSTRACT

A system and method for measuring three-dimensional coordinates is provided. The system includes an aerial drone, an optical scanning device and a processor system. The aerial drone includes a plurality of landing support legs on one side and a plurality of plurality of support struts on an opposite side, the aerial drone having at least one thrust device. The optical scanning device is coupled to the aerial drone, the optical scanning device being configured to measure three-dimensional coordinates of at least one point. The processor system is configured to position the plurality of support struts against a surface in the environment using the thrust devices prior to operating the optical scanning device.

### CROSS REFERENCE TO RELATED APPLICATIONS

This application claims the benefit of U.S. Provisional Application Ser. No. 62/799,270, filed Jan. 31, 2019, the entire disclosure of which is incorporated herein by reference.

### BACKGROUND

The present invention relates generally to a system and method for measuring three-dimensional coordinates and, more specifically, to a system and method for measuring three-dimensional coordinates using autonomous drones or unmanned aerial vehicles during flight.

Autonomous drones, also referred to as unmanned aerial vehicles (UAVs) and remotely piloted aircraft (RPA), have been used to measure three-dimensional coordinates as in some cases they provide a cost effective way to measure objects or environments without incurring the effort and expense of building structures to support the scanning devices. While these systems allow for the rapid acquisition of coordinates in a wide variety of environments, the accuracy level of measurements may be less than desired since the position of the UAV or RPA may change during the scanning process. Typically a time-of-flight type scanner has an accuracy on the order of a millimeter when properly mounted on a stable fixture or surface. This accuracy may drop to several centimeters when performed by a drone mounted scanner.

Accordingly, while existing UAV and RPA scanning systems are suitable for their intended purposes the need for improvement remains, particularly in providing a UVA or RPA based scanning system having the features described here.

### SUMMARY

According to an embodiment, a system for measuring three-dimensional coordinates is provided. The system includes an aerial drone having a plurality of landing support legs on one side and a plurality of plurality of support struts on an opposite side, the aerial drone having at least one thrust device. An optical scanning device is coupled to the aerial drone, the optical scanning device being configured to measure three-dimensional coordinates of at least one point. A processor system is configured to position the plurality of support struts against a surface in the environment using the thrust devices prior to operating the optical scanning device.

In addition to one or more of the features described herein, or as an alternative, further embodiments of the system may include wherein the aerial drone further having a plurality of support pads, each support pad being coupled to the end of one of the plurality of support struts. In addition to one or more of the features described herein, or as an alternative, further embodiments of the system may include the plurality of support pads being made from a silicone material. In addition to one or more of the features described herein, or as an alternative, further embodiments of the system may include the optical scanning device having a light source, a beam steering unit, and a light receiver. The beam steering unit cooperating with the light source and light receiver to define a scan area. The light source and the light receiver configured to cooperate with a processor system to determine a first distance to a first object point based at least in part on a transmitting of a light by the light source and a receiving of a reflected light by the light receiver. The 3D scanner configured to cooperate with the processor system to determine the three-dimensional coordinates of the at least one point based at least in part on the first distance.

In addition to one or more of the features described herein, or as an alternative, further embodiments of the system may include the optical scanning device being one of a time-of-flight scanner, a triangulation scanner, an area scanner, a structured light scanner, or a laser tracker. In addition to one or more of the features described herein, or as an alternative, further embodiments of the system may include the aerial drone includes a force sensor, wherein the processor system determines the struts are against the surface based on a signal from the force sensor. In addition to one or more of the features described herein, or as an alternative, further embodiments of the system may include the surface being a ceiling in the environment.

In accordance with another embodiment, a method of measuring three-dimensional coordinates is provided. The method includes moving an aerial drone from a first position to a scanning position. A plurality of support struts extending from the aerial drone contact onto a surface at the scanning position. Thrust generated by thrust devices on the aerial drone is increased. The aerial drone is held against the surface using the increased thrust. Three-dimensional coordinates of at least one point in an environment or on an object are measured with an optical scanning device on the aerial drone while the aerial drone is held against the surface.

In addition to one or more of the features described herein, or as an alternative, further embodiments of the method may include rotating the optical scanning device about a first axis, the optical scanning device having a light source, a light receiver and a photogrammetry camera. A plurality of light beams are emitted from the light source and receiving with the light receiver a plurality of reflected light beams from an object surface within a scan area, the direction of each of the plurality of light beams being determined by a beam steering unit. Wherein the step of measuring the three-dimensional coordinates of at least one point includes determining, with a processor system, three-dimensional coordinates of a collection of points on the environment or object within a scan area based at least in part on the plurality of light beams and the plurality of reflected light beams.

In addition to one or more of the features described herein, or as an alternative, further embodiments of the method may include acquiring at least one image within the field of view of a photogrammetry camera as the optical scanning device is rotated about the first axis. In addition to one or more of the features described herein, or as an alternative, further embodiments of the method may include colorizing the collection of points based on the at least one image. In addition to one or more of the features described herein, or as an alternative, further embodiments of the method may include the optical scanning device being one of a time-of-flight scanner, a triangulation scanner, an area scanner, a structured light scanner, or a laser tracker.

In addition to one or more of the features described herein, or as an alternative, further embodiments of the method may include measuring a force when the support struts contact the surface, and increasing the thrust from the thrust devices in response to measuring the force. In addition to one or more of the features described herein, or as an alternative, further embodiments of the method may include the surface is a ceiling in the environment.

Additional features are realized through the techniques of the present invention. Other embodiments and aspects of the invention are described in detail herein and are considered a part of the claimed invention. For a better understanding of the invention with the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features of embodiments of the invention are apparent from the following detailed description taken in conjunction with the accompanying drawings in which:

FIG. 1 depicts a block diagram of a drone in accordance with an embodiment of this disclosure;

FIG. 2 depicts a block diagram of a controller for a drone in accordance with an embodiment of this disclosure;

FIG. 3 depicts a side view of a scanning system using a drone in accordance with an embodiment of this disclosure;

FIG. 4 depicts a perspective view of the scanning system of FIG. 3;

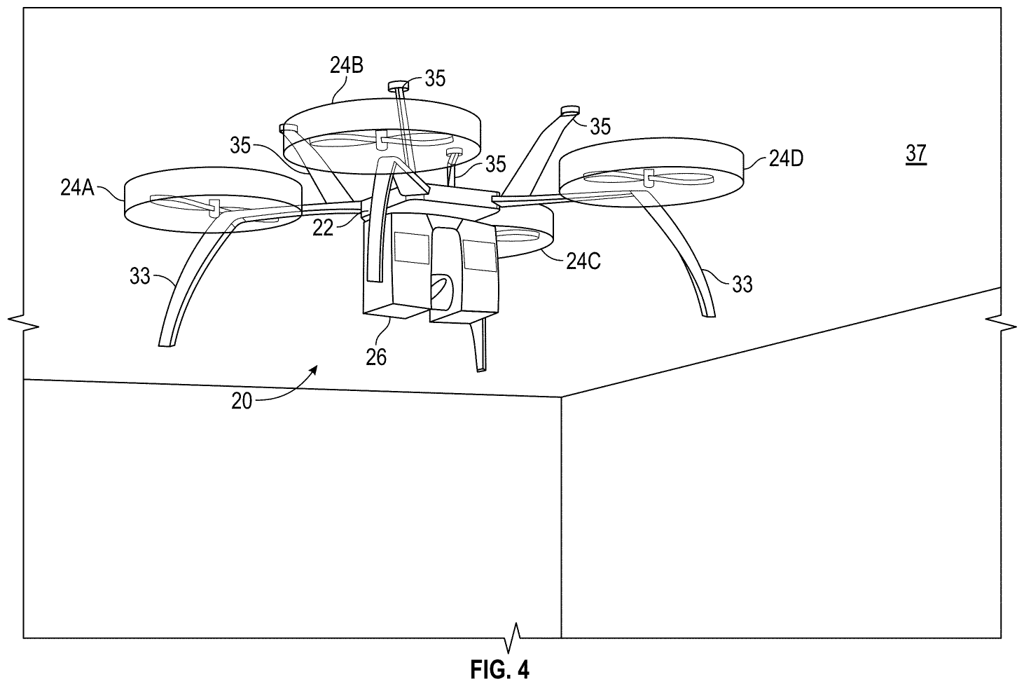

FIG. 5 depicts a flow diagram for operating the scanning system of FIG. 3;

FIG. 6 is a perspective view of a laser scanner in accordance with an embodiment of the disclosure;

FIG. 7 is a side view of the laser scanner illustrating a method of measurement according to an embodiment;

FIG. 8 is a schematic illustration of the optical, mechanical, and electrical components of the laser scanner according to an embodiment; and

FIG. 9 illustrates a schematic illustration of the laser scanner of FIG. 5 according to an embodiment.

### DETAILED DESCRIPTION

Embodiments of the present disclosure are directed to a system for measuring three-dimensional coordinates of an environment or an object using an unmanned aerial vehicle (UAV) and remotely piloted aircraft (RPA), which may be collectively referred to herein as a drone. Embodiments of the present disclosure provide for a stable platform for performing the measurements with an optical scanner to allow for improved accuracy of the three-dimensional (3D) coordinates.

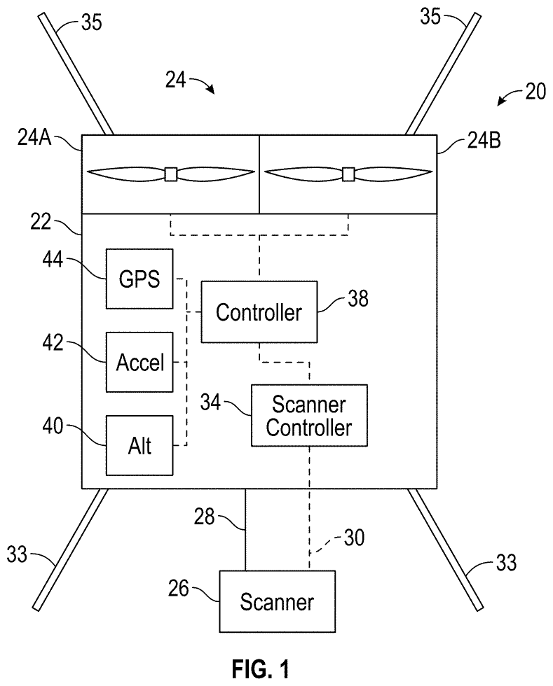

Referring now to FIG. 1, an embodiment is shown of an autonomous drone 20 or unmanned aerial vehicle. As used herein, the term “drone” refers to either a remotely operated aerial vehicle piloted by a human operator, or an aerial vehicle capable to operating autonomously or semi-autonomously from a human operator to perform a predetermined function, such as scan an object or environment for example. The drone 20 includes a fuselage 22 that supports at least one thrust device 24. In an embodiment, the drone 20 includes a plurality of thrust devices 24A, 24B, such as four thrust devices arranged about the periphery of the fuselage 22. In an embodiment, the thrust devices 24 include propeller member that rotates to produce thrust. The thrust devices 24 may be configurable to provide both lift (vertical thrust) and lateral thrust (horizontal thrust). The vertical and horizontal components of the thrust allow the changing of the altitude, lateral movement and orientation (attitude) of the drone 20.

In the exemplary embodiment, the fuselage 22 and thrust devices 24 are sized and configured to carry a payload such as an optical scanner 26 that is configured to measure three-dimensional coordinates of points in the environment or on an object. The scanner 26 may be a time-of-flight scanner, a triangulation scanner, an area scanner, a structured light scanner, or a laser tracker for example. In an embodiment, the scanner 26 may be releasably coupled to the fuselage 22 by a coupling 28. In another embodiment, the scanner 26 may be integral with or fixedly coupled to the fuselage 22. As will be discussed in more detail herein, the scanner 26 may also be coupled to a scanner controller 32 by a communication and power connection 30. It should be appreciated that the scanner controller 32 may be located in the scanner 26, within the fuselage 22, or include multiple processing units that are distributed between the scanner 26, the fuselage 22, or are remotely located from the drone 20. The scanner controller 34 may be coupled to communicate with a drone controller 38.

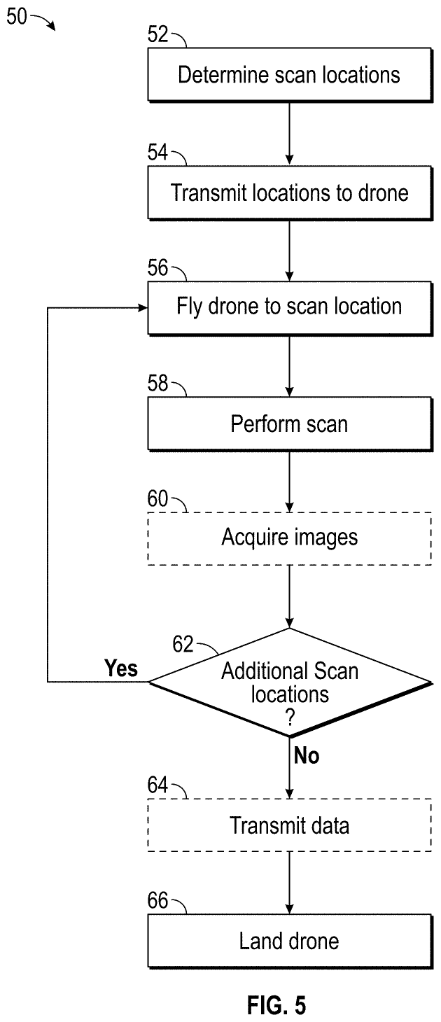

Both the drone controller 38 and the scanner controller 34 may include processors that are responsive to operation control methods embodied in application code such as those shown in FIG. 5. These methods are embodied in computer instructions written to be executed by the processor, such as in the form of software. The controller 38 is coupled transmit and receive signals from the thrust devices 24, The controller 38 may further be coupled to one or more sensor devices that enable to the controller to determine the position, orientation and altitude of the drone 20. In an embodiment, these sensors may include an altimeter 40, a gyroscope or accelerometers 42 or a global positioning satellite (GPS) system 44. In other embodiments, the controller 38 may be coupled to other sensors, such as force sensors for example, that allow the controller 38 to determine when the scanning support struts 35 are in contact with a surface, such as the ceiling for example.

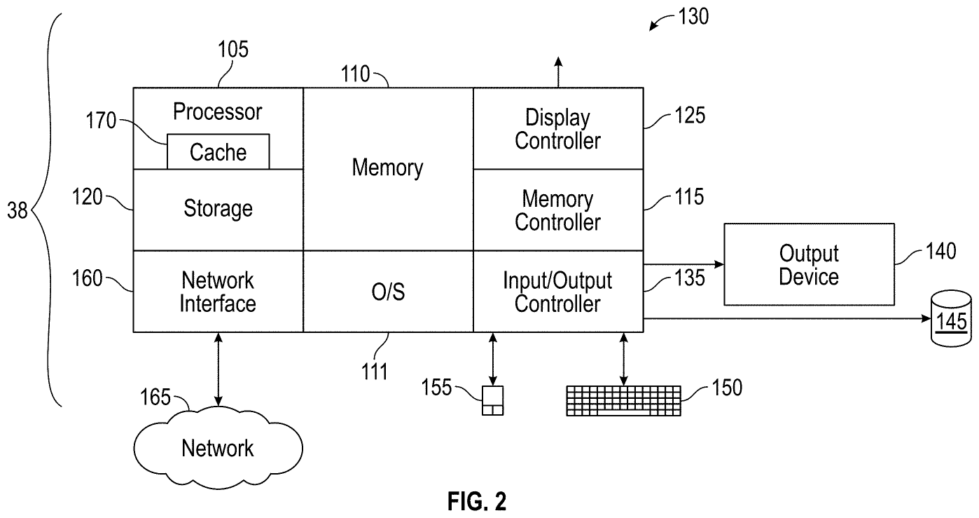

FIG. 2 illustrates a block diagram of a controller 38 for use in implementing a system or method according to some embodiments. The systems and methods described herein may be implemented in hardware, software (e.g., firmware), or a combination thereof. In some embodiments, the methods described may be implemented, at least in part, in hardware and may be part of the microprocessor of a special or general-purpose controller 38, such as a personal computer, workstation, minicomputer, or mainframe computer.

In some embodiments, as shown in FIG. 2, the controller 38 includes a processor 105, memory 110 coupled to a memory controller 115, and one or more input devices 145 and/or output devices 140, such as peripheral or control devices, which are communicatively coupled via a local I/O controller 135. These devices 140 and 145 may include, for example, battery sensors, position sensors (altimeter 40, accelerometer 42, GPS 44), indicator/identification lights and the like. Input devices such as a conventional keyboard 150 and mouse 155 may be coupled to the I/O controller 135 when the drone is docked to allow personnel to service or input information. The I/O controller 135 may be, for example, one or more buses or other wired or wireless connections, as are known in the art. The I/O controller 135 may have additional elements, which are omitted for simplicity, such as controllers, buffers (caches), drivers, repeaters, and receivers, to enable communications.

The I/O devices 140, 145 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 105 is a hardware device for executing hardware instructions or software, particularly those stored in memory 110. The processor 105 may be a custom made or commercially available processor, a central processing unit (CPU), an auxiliary processor among several processors associated with the controller 38, a semiconductor based microprocessor (in the form of a microchip or chip set), a macroprocessor, or other device for executing instructions. The processor 105 includes a cache 170, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 170 may be organized as a hierarchy of more cache levels (L1, L2, etc.).

The memory 110 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, or other types of storage media. Note that the memory 110 may have a distributed architecture, where various components are situated remote from one another but may be accessed by the processor 105.

The instructions in memory 110 may include one or more separate programs, each of which comprises an ordered listing of executable instructions for implementing logical functions. In the example of FIG. 2, the instructions in the memory 110 include a suitable operating system (OS) 111. The operating system 111 essentially may control the execution of other computer programs and provides scheduling, input-output control, file and data management, memory management, and communication control and related services.

Additional data, including, for example, instructions for the processor 105 or other retrievable information, may be stored in storage 120, which may be a storage device such as a hard disk drive or solid state drive. The stored instructions in memory 110 or in storage 120 may include those enabling the processor to execute one or more aspects of the systems and methods of this disclosure.

The controller 38 may further include a display controller 125 coupled to a user interface or display 130. In some embodiments, the display 130 may be an LCD screen. In other embodiments, the display 130 may include a plurality of LED status lights. In some embodiments, the controller 38 may further include a network interface 160 for coupling to a network 165. The network 165 may be an IP-based network for communication between the controller 38 and an external server, client and the like via a broadband connection. In an embodiment, the network 165 may be a satellite network. The network 165 transmits and receives data between the controller 38 and external systems. In some embodiments, the network 165 may be a managed IP network administered by a service provider. The network 165 may be implemented in a wireless fashion, e.g., using wireless protocols and technologies, such as WiFi, WiMax, satellite, etc. The network 165 may also be a packet-switched network such as a local area network, wide area network, metropolitan area network, the Internet, or other similar type of network environment. The network 165 may be a fixed wireless network, a wireless local area network (LAN), a wireless wide area network (WAN) a personal area network (PAN), a virtual private network (VPN), intranet or other suitable network system and may include equipment for receiving and transmitting signals.

Systems and methods according to this disclosure may be embodied, in whole or in part, in computer program products or in controller 38, such as that illustrated in FIG. 2.

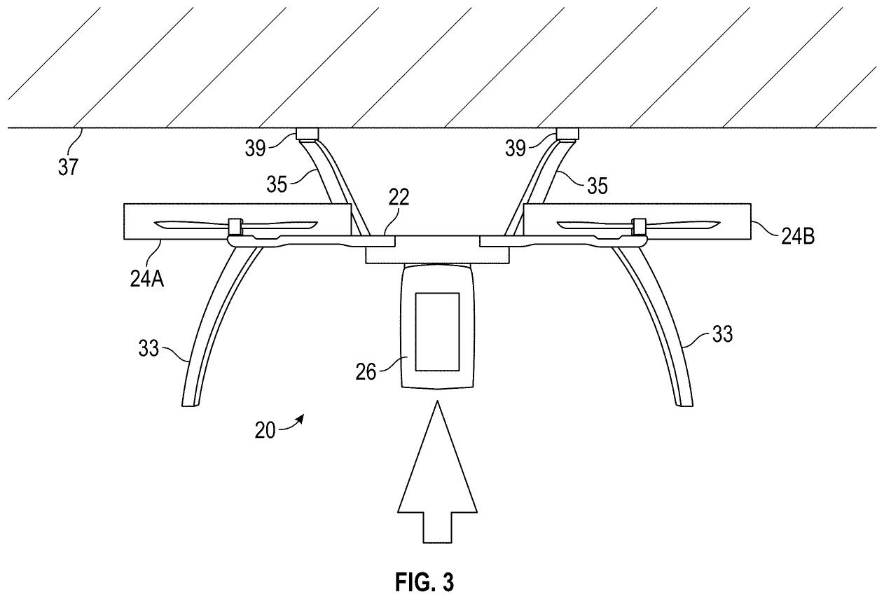

Referring now to FIG. 3, an embodiment is shown of a drone 20 that is configured to provide a stable platform for performing measurements with the scanner 26. It should be appreciated that when highly accurate measurements (e.g. 1-5 millimeters, or 1-2 millimeters accuracy) are to be performed by an optical scanning system, the scanner 26 should be held stable during the measurements. One issue with existing drone based scanning systems is that the stability of the drone reduces the accuracy of the measurements to be about 1 centimeter. In the illustrated embodiment, the drone 20 includes a plurality of thrust devices 24A-24D that are configured to provide a thrust force that supports the fuselage 22 and the scanner 26. It should be appreciated that while the illustrated embodiment shows four thrust devices, this is for exemplary purposes and the drone 20 may have 2, 3, 4, 5 or more thrust devices. Extending from the fuselage 22 are a plurality of landing supports 33. In the illustrated embodiment, there are four landing supports 33 that are arranged about the fuselage 22. The landing supports 33 are located on a side of the fuselage that is opposite the thrust devices 24A-24D. In an embodiment, the landing supports 33 have a length that is sufficient to allow the drone 20 to land on the ground, a support surface or a docking station while keeping the scanner from touching the landing surface.

The drone 20 also includes a plurality of scanning support struts 35. In the illustrated embodiment, there are four struts 35, but there may be 3, 4, 5 or more support struts 35. The struts 35 extend from the fuselage 22 on a side opposite the landing supports 33. In an embodiment, the struts 35 may be arranged adjacent the thrust devices 24A-24D. The struts 35 have a length sufficient to allow the drone 20 to cause the struts 35 to contact a surface, such as the ceiling 37 and be held in place using the thrust generated by the thrusting devices 24A-24D. As will be discussed in more detail herein, the drone is configured to place the struts 35 against the surface 37 and hold the drone in place using thrust from the thrust devices during the scanning process. In an embodiment, the struts 35 include pads 39. In an embodiment, the pads 39 are made from a silicone material to provide improved traction with the surface 37.

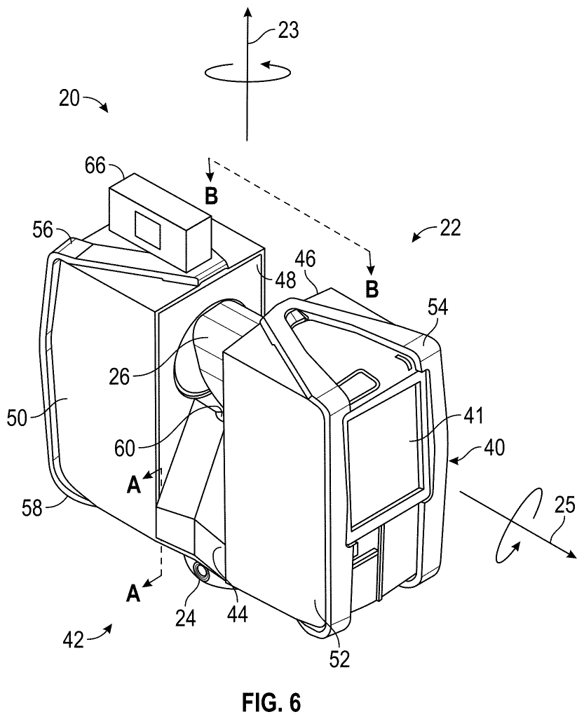

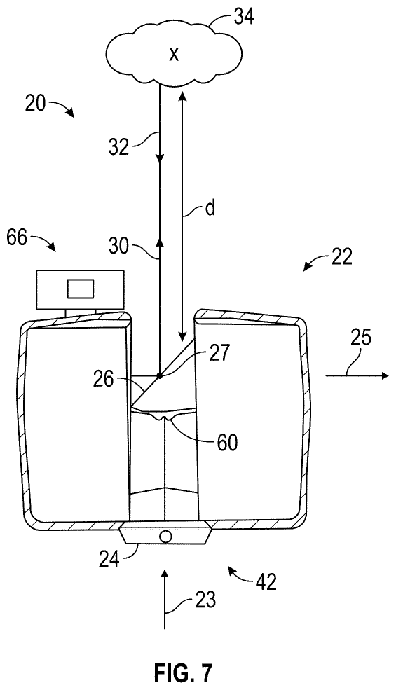

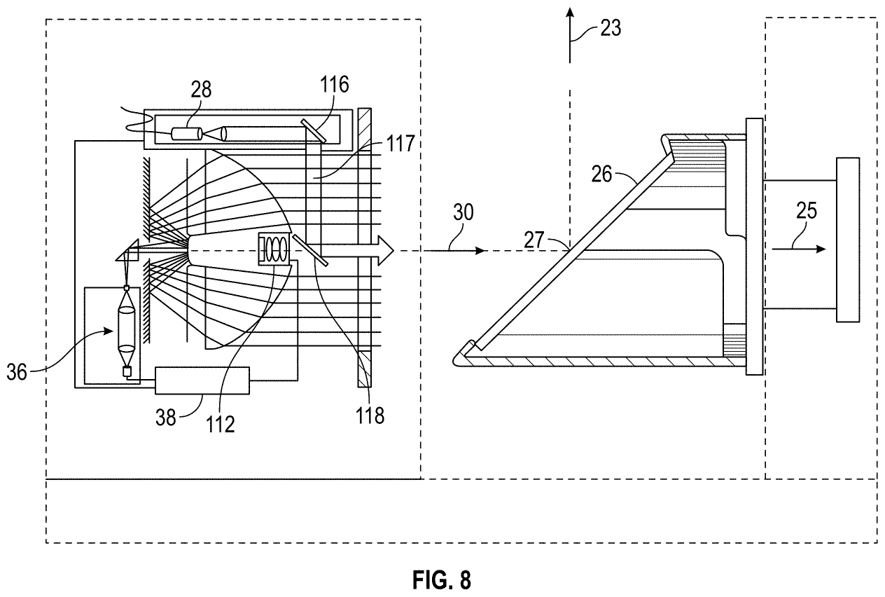

Referring now to FIG. 5, a method 50 is shown for performing a three-dimensional coordinate measurements using a drone 20 having a scanner 26. The method begins in block 52 where the scanning locations are determined. It should be appreciated that in some embodiments multiple scans may need to be performed to acquire data from the desired area or object (e.g. avoid having areas shadowed from the scanner by structures). These locations are transmitted to the drone 20 in block 54 and the drone 20 is flown to the location in block 56. When at the location, the drone 20 places the struts 35 into contact with a surface, such as the ceiling or roof of the building in which the scanning will take place for example. When in contact with the surface, the thrust devices 24A-24D are operated to provide sufficient force to hold the drone stably and steady against the surface. With the drone 20 firmly held against the surface 37 by the thrust devices 24A-24D, the method 50 proceeds to block 58 where the three-dimensional measurements are made using the scanner 26. In an embodiment, the scanner 26 is a time-of-flight type scanner, such as that described with respect to FIGS. 6-9. In some embodiments, the time to perform the measurements with the scanner 26 can range from 1-60 minutes or more.

The method 50 then proceeds to optional block 60 where images of the environment or object being measured may be acquired. In an embodiment, the images are color images that may be used to colorize the points measured by the scanner 26. In an embodiment multiple images are acquired. In an embodiment, the images are acquired simultaneously with block 58.

The method 50 then proceeds to block 62 where it is determined if additional scans are desired. If an affirmative response from query block 62 is received, the method 50 loops back to block 56 where the drone 20 is flown to the next location and the process continues until measurements have been made at all of the desired locations. When query block 62 returns a negative, the method 50 proceeds to optional block 64 where the measurement data may be transmitted to a remote computer. In an embodiment, the measurement data is stored in memory, such as a removable secure digital (SD) card. In other embodiments, the data may be transmitted wirelessly from the drone 20 to a remote computer via a network. The method 50 then ends in block 66 where the drone 20 is landed. It should be appreciated that optional block 64 may be performed before, during or after block 66. In an embodiment, the data may be transmitted after each scan is complete, such as when the method 50 loops from query block 62 to block 56.

In an embodiment, the scanner 26 may be the time-of-flight laser scanner 120 shown in FIGS. 6-9. The laser scanner 120 is shown for optically scanning and measuring the environment surrounding the laser scanner 120. The laser scanner 120 has a measuring head 122 and a base 124. The measuring head 122 is mounted on the base 124 such that the laser scanner 120 may be rotated about a vertical axis 123. In one embodiment, the measuring head 122 includes a gimbal point 127 that is a center of rotation about the vertical axis 123 and a horizontal axis 125. The measuring head 122 has a rotary mirror 126, which may be rotated about the horizontal axis 125. The rotation about the vertical axis may be about the center of the base 124. The terms vertical axis and horizontal axis refer to the scanner in its normal upright position. It is possible to operate a 3D coordinate measurement device on its side or upside down, and so to avoid confusion, the terms azimuth axis and zenith axis may be substituted for the terms vertical axis and horizontal axis, respectively. The term pan axis or standing axis may also be used as an alternative to vertical axis.

The measuring head 122 is further provided with an electromagnetic radiation emitter, such as light emitter 128, for example, that emits an emitted light beam 130. In one embodiment, the emitted light beam 130 is a coherent light beam such as a laser beam. The laser beam may have a wavelength range of approximately 300 to 1600 nanometers, for example 790 nanometers, 905 nanometers, 1550 nm, or less than 400 nanometers. It should be appreciated that other electromagnetic radiation beams having greater or smaller wavelengths may also be used. The emitted light beam 130 is amplitude or intensity modulated, for example, with a sinusoidal waveform or with a rectangular waveform. The emitted light beam 130 is emitted by the light emitter 128 onto a beam steering unit, such as mirror 126, where it is deflected to the environment. A reflected light beam 132 is reflected from the environment by an object 134. The reflected or scattered light is intercepted by the rotary mirror 26 and directed into a light receiver 136. The directions of the emitted light beam 130 and the reflected light beam 132 result from the angular positions of the rotary mirror 126 and the measuring head 122 about the axes 125 and 123, respectively. These angular positions in turn depend on the corresponding rotary drives or motors.

Coupled to the light emitter 128 and the light receiver 36 is a controller 138. The controller 138 determines, for a multitude of measuring points X, a corresponding number of distances d between the laser scanner 120 and the points X on object 134. The distance to a particular point X is determined based at least in part on the speed of light in air through which electromagnetic radiation propagates from the device to the object point X. In one embodiment the phase shift of modulation in light emitted by the laser scanner 120 and the point X is determined and evaluated to obtain a measured distance d.

The speed of light in air depends on the properties of the air such as the air temperature, barometric pressure, relative humidity, and concentration of carbon dioxide. Such air properties influence the index of refraction n of the air. The speed of light in air is equal to the speed of light in vacuum c divided by the index of refraction. In other words, cair=c/n. A laser scanner of the type discussed herein is based on the time-of-flight (TOF) of the light in the air (the round-trip time for the light to travel from the device to the object and back to the device). Examples of TOF scanners include scanners that measure round trip time using the time interval between emitted and returning pulses (pulsed TOF scanners), scanners that modulate light sinusoidally and measure phase shift of the returning light (phase-based scanners), as well as many other types. A method of measuring distance based on the time-of-flight of light depends on the speed of light in air and is therefore easily distinguished from methods of measuring distance based on triangulation. Triangulation-based methods involve projecting light from a light source along a particular direction and then intercepting the light on a camera pixel along a particular direction. By knowing the distance between the camera and the projector and by matching a projected angle with a received angle, the method of triangulation enables the distance to the object to be determined based on one known length and two known angles of a triangle. The method of triangulation, therefore, does not directly depend on the speed of light in air.

In one mode of operation, the scanning of the volume around the laser scanner 120 takes place by rotating the rotary mirror 126 relatively quickly about axis 125 while rotating the measuring head 122 relatively slowly about axis 123, thereby moving the assembly in a spiral pattern. In an exemplary embodiment, the rotary mirror rotates at a maximum speed of 5820 revolutions per minute. For such a scan, the gimbal point 127 defines the origin of the local stationary reference system. The base 124 rests in this local stationary reference system.

In addition to measuring a distance d from the gimbal point 127 to an object point X, the scanner 120 may also collect gray-scale information related to the received optical power (equivalent to the term “brightness.”) The gray-scale value may be determined at least in part, for example, by integration of the bandpass-filtered and amplified signal in the light receiver 136 over a measuring period attributed to the object point X.

The measuring head 122 may include a display device 140 integrated into the laser scanner 120. The display device 140 may include a graphical touch screen 141, as shown in FIG. 6, which allows the operator to set the parameters or initiate the operation of the laser scanner 120. For example, the screen 141 may have a user interface that allows the operator to provide measurement instructions to the device, and the screen may also display measurement results.

The laser scanner 120 includes a carrying structure 142 that provides a frame for the measuring head 122 and a platform for attaching the components of the laser scanner 120. In one embodiment, the carrying structure 142 is made from a metal such as aluminum. The carrying structure 142 includes a traverse member 144 having a pair of walls 146, 148 on opposing ends. The walls 146, 148 are parallel to each other and extend in a direction opposite the base 124. Shells 150, 152 are coupled to the walls 146, 148 and cover the components of the laser scanner 120. In the exemplary embodiment, the shells 150, 152 are made from a plastic material, such as polycarbonate or polyethylene for example. The shells 150, 152 cooperate with the walls 146, 148 to form a housing for the laser scanner 120.

On an end of the shells 150, 152 opposite the walls 146, 148 a pair of yokes 154, 156 are arranged to partially cover the respective shells 150, 152. In the exemplary embodiment, the yokes 154, 156 are made from a suitably durable material, such as aluminum for example, that assists in protecting the shells 150, 152 during transport and operation. The yokes 154, 156 each includes a first arm portion 158 that is coupled, such as with a fastener for example, to the traverse 144 adjacent the base 124. The arm portion 158 for each yoke 154, 156 extends from the traverse 144 obliquely to an outer corner of the respective shell 150, 152. From the outer corner of the shell, the yokes 154, 156 extend along the side edge of the shell to an opposite outer corner of the shell. Each yoke 154, 156 further includes a second arm portion that extends obliquely to the walls 146, 148. It should be appreciated that the yokes 154, 156 may be coupled to the traverse 142, the walls 146, 148 and the shells 150, 154 at multiple locations.

The pair of yokes 154, 156 cooperate to circumscribe a convex space within which the two shells 150, 152 are arranged. In the exemplary embodiment, the yokes 154, 156 cooperate to cover all of the outer edges of the shells 150, 154, while the top and bottom arm portions project over at least a portion of the top and bottom edges of the shells 150, 152. This provides advantages in protecting the shells 150, 152 and the measuring head 122 from damage during transportation and operation. In other embodiments, the yokes 154, 156 may include additional features, such as handles to facilitate the carrying of the laser scanner 120 or attachment points for accessories for example.

On top of the traverse 144, a prism 160 is provided. The prism extends parallel to the walls 146, 148. In the exemplary embodiment, the prism 160 is integrally formed as part of the carrying structure 142. In other embodiments, the prism 160 is a separate component that is coupled to the traverse 144. When the mirror 126 rotates, during each rotation the mirror 126 directs the emitted light beam 130 onto the traverse 144 and the prism 160. Due to non-linearities in the electronic components, for example in the light receiver 136, the measured distances d may depend on signal strength, which may be measured in optical power entering the scanner or optical power entering optical detectors within the light receiver 136, for example. In an embodiment, a distance correction is stored in the scanner as a function (possibly a nonlinear function) of distance to a measured point and optical power (generally unscaled quantity of light power sometimes referred to as “brightness”) returned from the measured point and sent to an optical detector in the light receiver 136. Since the prism 160 is at a known distance from the gimbal point 127, the measured optical power level of light reflected by the prism 160 may be used to correct distance measurements for other measured points, thereby allowing for compensation to correct for the effects of environmental variables such as temperature. In the exemplary embodiment, the resulting correction of distance is performed by the controller 138.

In an embodiment, the base 124 is coupled to a swivel assembly (not shown) such as that described in commonly owned U.S. Pat. No. 8,705,012 ('012), which is incorporated by reference herein. The swivel assembly is housed within the carrying structure 142 and includes a motor 138 that is configured to rotate the measuring head 122 about the axis 123. In an embodiment, the angular/rotational position of the measuring head 122 about the axis 123 is measured by angular encoder 234.

An auxiliary image acquisition device 166 may be a device that captures and measures a parameter associated with the scanned area or the scanned object and provides a signal representing the measured quantities over an image acquisition area. The auxiliary image acquisition device 166 may be, but is not limited to, a pyrometer, a thermal imager, an ionizing radiation detector, or a millimeter-wave detector. In an embodiment, the auxiliary image acquisition device 166 is a color camera.

In an embodiment, a central color camera (first image acquisition device) 212 is located internally to the scanner and may have the same optical axis as the 3D scanner device. In this embodiment, the first image acquisition device 212 is integrated into the measuring head 122 and arranged to acquire images along the same optical pathway as emitted light beam 130 and reflected light beam 132. In this embodiment, the light from the light emitter 128 reflects off a fixed mirror 216 and travels to dichroic beam-splitter 218 that reflects the light 217 from the light emitter 128 onto the rotary mirror 126. In an embodiment, the mirror 126 is rotated by a motor 236 and the angular/rotational position of the mirror is measured by angular encoder 234. The dichroic beam-splitter 218 allows light to pass through at wavelengths different than the wavelength of light 217. For example, the light emitter 128 may be a near infrared laser light (for example, light at wavelengths of 780 nm or 1150 nm), with the dichroic beam-splitter 218 configured to reflect the infrared laser light while allowing visible light (e.g., wavelengths of 400 to 700 nm) to transmit through. In other embodiments, the determination of whether the light passes through the beam-splitter 218 or is reflected depends on the polarization of the light. The digital camera 212 obtains 2D images of the scanned area to capture color data to add to the scanned image. In the case of a built-in color camera having an optical axis coincident with that of the 3D scanning device, the direction of the camera view may be easily obtained by simply adjusting the steering mechanisms of the scanner—for example, by adjusting the azimuth angle about the axis 123 and by steering the mirror 126 about the axis 125.

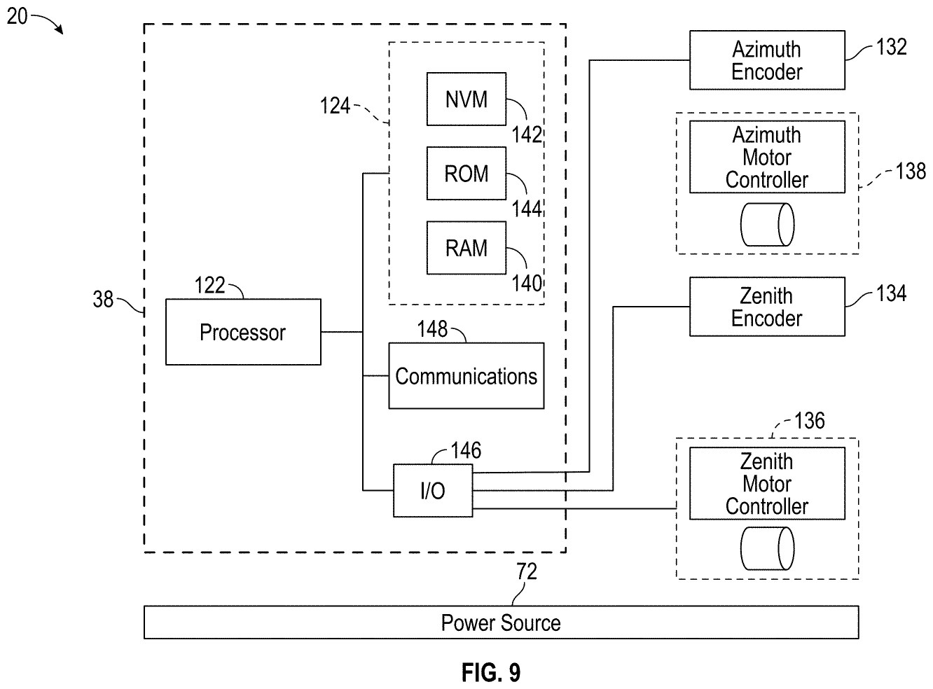

Referring now to FIG. 9 with continuing reference to FIGS. 6-8, elements are shown of the laser scanner 120. Controller 138 is a suitable electronic device capable of accepting data and instructions, executing the instructions to process the data, and presenting the results. It should be appreciated that in some embodiments, the controller 34 is the same element as controller 138. The controller 138 includes one or more processing elements 222. The processors may be microprocessors, field programmable gate arrays (FPGAs), digital signal processors (DSPs), and generally any device capable of performing computing functions. The one or more processors 222 have access to memory 224 for storing information.

Controller 138 is capable of converting the analog voltage or current level provided by light receiver 136 into a digital signal to determine a distance from the laser scanner 120 to an object in the environment. Controller 138 uses the digital signals that act as input to various processes for controlling the laser scanner 120. The digital signals represent one or more laser scanner 120 data including but not limited to distance to an object, images of the environment, images acquired by panoramic camera 226, angular/rotational measurements by a first or azimuth encoder 232, and angular/rotational measurements by a second axis or zenith encoder 234.

In general, controller 138 accepts data from encoders 232, 234, light receiver 136, light source 128, and panoramic camera 226 and is given certain instructions for the purpose of generating a 3D point cloud of a scanned environment. Controller 138 provides operating signals to the light source 128, light receiver 136, panoramic camera 226, zenith motor 236 and azimuth motor 238. The controller 138 compares the operational parameters to predetermined variances and if the predetermined variance is exceeded, generates a signal that alerts an operator to a condition. The data received by the controller 138 may be displayed on a user interface 140 coupled to controller 138. The user interface 240 may be one or more LEDs (light-emitting diodes) 182, an LCD (liquid-crystal diode) display, a CRT (cathode ray tube) display, a touch-screen display or the like. A keypad may also be coupled to the user interface for providing data input to controller 138. In one embodiment, the user interface is arranged or executed on a mobile computing device that is coupled for communication, such as via a wired or wireless communications medium (e.g. Ethernet, serial, USB, Bluetooth™ or WiFi) for example, to the laser scanner 120.

The controller 138 may also be coupled to external computer networks such as a local area network (LAN) and the Internet. A LAN interconnects one or more remote computers, which are configured to communicate with controller 38 using a well-known computer communications protocol such as TCP/IP (Transmission Control Protocol/Internet(\hat{ }) Protocol), RS-232, ModBus, and the like. Additional systems 20 may also be connected to LAN with the controllers 138 in each of these systems 120 being configured to send and receive data to and from remote computers and other systems 120. The LAN may be connected to the Internet. This connection allows controller 138 to communicate with one or more remote computers connected to the Internet.

The processors 222 are coupled to memory 224. The memory 224 may include random access memory (RAM) device 240, a non-volatile memory (NVM) device 242, and a read-only memory (ROM) device 244. In addition, the processors 222 may be connected to one or more input/output (I/O) controllers 246 and a communications circuit 248. In an embodiment, the communications circuit 192 provides an interface that allows wireless or wired communication with one or more external devices or networks, such as the LAN discussed above.

Controller 138 includes operation control methods embodied in application code shown in FIG. 5. These methods are embodied in computer instructions written to be executed by processors 222, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, C#, Objective-C, Visual C++, Java, ALGOL (algorithmic language), BASIC (beginners all-purpose symbolic instruction code), visual BASIC, ActiveX, HTML (HyperText Markup Language), Python, Ruby and any combination or derivative of at least one of the foregoing.

Technical effects and benefits of some embodiments include the efficient measurement of three-dimensional coordinates of an environment or an object with a desired level accuracy using a drone that can stabilize itself on a surface such as a ceiling.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system for measuring three-dimensional coordinates, the system comprising:
an aerial drone having a plurality of landing support legs on one side and a plurality of plurality of support struts on an opposite side, the aerial drone having at least one thrust device;
an optical scanning device coupled to the aerial drone, the optical scanning device being configured to measure three-dimensional coordinates of at least one point; and
a processor system configured to position the plurality of support struts against a surface in the environment using the thrust devices prior to operating the optical scanning device.

2. The system of claim 1, wherein the aerial drone further includes a plurality of support pads, each support pad being coupled to the end of one of the plurality of support struts.

3. The system of claim 2, wherein the plurality of support pads are made from a silicone material.

4. The system of claim 1, wherein the optical scanning device includes a light source, a beam steering unit, and a light receiver, the beam steering unit cooperating with the light source and light receiver to define a scan area, the light source and the light receiver configured to cooperate with a processor system to determine a first distance to a first object point based at least in part on a transmitting of a light by the light source and a receiving of a reflected light by the light receiver, the 3D scanner configured to cooperate with the processor system to determine the three-dimensional coordinates of the at least one point based at least in part on the first distance.

5. The system of claim 1, wherein the optical scanning device is one of a time-of-flight scanner, a triangulation scanner, an area scanner, a structured light scanner, or a laser tracker.

6. The system of claim 1, wherein the aerial drone includes a force sensor, wherein the processor system determines the struts are against the surface based on a signal from the force sensor.

7. The system of claim 1, wherein the surface is a ceiling in the environment.

8. A method of measuring three-dimensional coordinates, the method comprising:
moving an aerial drone from a first position to a scanning position;
contacting a plurality of support struts extending from the aerial drone onto a surface at the scanning position;
increasing thrust generated by thrust devices on the aerial drone;
holding the aerial drone against the surface using the increased thrust; and
measuring three-dimensional coordinates of at least one point in an environment or on an object with an optical scanning device on the aerial drone while the aerial drone is held against the surface.

9. The method of claim 8, further comprising
rotating the optical scanning device about a first axis, the optical scanning device having a light source, a light receiver and a photogrammetry camera;
emitting a plurality of light beams from the light source and receiving with the light receiver a plurality of reflected light beams from an object surface within a scan area, the direction of each of the plurality of light beams being determined by a beam steering unit; and
wherein the step of measuring the three-dimensional coordinates of at least one point includes determining, with a processor system, three-dimensional coordinates of a collection of points on the environment or object within a scan area based at least in part on the plurality of light beams and the plurality of reflected light beams.

10. The method of claim 9, further comprising acquiring at least one image within the field of view of a photogrammetry camera as the optical scanning device is rotated about the first axis.

11. The method of claim 10 further comprising colorizing the collection of points based on the at least one image.

12. The method of claim 8, wherein the optical scanning device is one of a time-of-flight scanner, a triangulation scanner, an area scanner, a structured light scanner, or a laser tracker.

13. The method of claim 8, further comprising measuring a force when the support struts contact the surface, and increasing the thrust from the thrust devices in response to measuring the force.

14. The method of claim 8, wherein the surface is a ceiling in the environment.
